(19) United States
(12) Patent Application Publication
(10) Pub. No.: US 2016/0379510 A1
(43) Pub. Date: Dec. 29, 2016

(54) SYSTEM AND METHOD FOR ADJUSTING THE DIFFICULTY OF A COMPUTER-IMPLEMENTED QUIZ

(71) Applicant: QuizFortune Limited, Belfast (GB)

(72) Inventors: Vincent Rainey, Dunloy (GB); Andrew Bowd, Belfast (GB); Colm Hayden, Belfast (GB)

(21) Appl. No.: 14/754,482

(22) Filed: Jun. 29, 2015

(51) Int. Cl. G09B 7/06

(52) U.S. Cl. CPC G09B 7/06

(57) ABSTRACT

A computer-implemented method of delivering a quiz that includes adjusting the difficulty of the quiz in response to a player's performance. Ranking data that enables the relative difficulty of the respective instances of each question to be determined is maintained and a target performance level for the player is determined. The player's current performance level is compared to the target performance level and the next question is selected depending on the result of the comparison.

A more difficult question than the previous question is selected as the next question if the comparison indicates that the user's current performance level exceeds the target performance level, otherwise a less difficult question is selected.

### FIELD OF THE INVENTION

The present invention relates to computer-implemented quizzes, particularly on-line quizzes. The invention relates especially to adjusting the difficulty of a computer-implemented quiz to maximize player engagement.

### BACKGROUND TO THE INVENTION

To optimize the engagement of a player, a quiz should ideally have an optimal difficulty level; not too easy and not too difficult for the player. Unlike traditional skill-based games where the game difficulty can easily be adjusted to meet the skill level of a player, in a trivia-based game such as a quiz, socio-demographic factors relevant to the player can affect the player's ability to answer questions. This is a particular problem in the field of computer-implemented quizzes where suitably engaging questions cannot be automatically generated by conventional software alone so adjusting question difficulty to suit a player is much more complex.

It would be desirable to provide a computer implemented quiz in which the difficulty level is adjusted, preferably taking information such as socio-demographic factors into account, in order to optimise the engagement of the player.

### SUMMARY OF THE INVENTION

A first aspect of the invention provides a computer-implemented method of delivering a quiz comprising a plurality of questions to at least one player using a computer system, the computer system comprising at least one server computing device in communication with at least one client computing device across a telecommunications network, the method comprising operating said computer system to:

store, in respect of each question, data representing a plurality of instances of said question in a computer usable format, each instance being associated with a different difficulty level;

maintain, in respect of each question, ranking data that enables the relative difficulty of the respective instances of each question to be determined;

determine a respective target performance level for a said at least one player;

present at said at least one client computing device a respective one of said instances of at least one question to said at least one player;

receive at said at least one client computing device a respective response to said at least one question from said at least one player;

calculate from said respective response a current performance level for said at least one player;

compare said current performance level to said target performance level;

select one of said instances of a next question depending on said comparison; and present said selected instance of said next question to said at least one player by said at least one computing client device,

wherein said selecting involves:
selecting one of said instances of said next question that is identified by said respective ranking data as being more difficult than the presented instance of a previously presented question if said comparing indicates that said current performance level exceeds said target performance level; and
selecting one of said instances of said next question that is identified by said respective ranking data as being less difficult than the presented instance of the previously presented question if said comparing indicates that said current performance level is lower than said target performance level.

Preferably, said data representing a plurality of instances of said question comprises data representing the respective question, a correct answer to the question and a respective different combination of wrong answers.

Preferably, said ranking data comprises, in respect of each wrong answer, data that is indicative of the respective probability that said at least one player would select the respective wrong answer as the correct answer.

The preferred method further includes operating said computer system to receive said data that is indicative of the respective probability that said at least one player would select the respective wrong answer as the correct answer as an input at a respective one of said at least one client devices.

Preferably, the method includes calculating said data that is indicative of the respective probability that said at least one player would select the respective wrong answer as the correct answer from responses to the respective question made by said at least one player using said at least one client computing device, said calculating said data typically being performed in respect of responses to the respective question made by a plurality of said at least one players.

The preferred method includes operating said computer system to maintain player profile data for each of said at least one players, said player profile data including data that is indicative of one or more sociological and/or one or more demographical characteristics of the respective player, said data advantageously being indicative of one or more sociological and/or one or more demographical characteristics of the respective player comprises data indicative of any one or more of the respective player's age, gender, nationality or place of residence.

Preferably, the method further includes operating said computer system to maintain player profile data for each of said at least one players, said player profile data including data that is indicative of the respective player's interaction with the computer system. Said data is typically indicative of the respective player's interaction with the system comprises data indicative of any one or more of a number of times the player has played the quiz, the frequency with which the player uses the computer system, the length of time the player engages with the system (on average and/or for each engagement), the player's performance in answering said questions (on average and/or for each engagement), said target performance for said player, a skill level for said player.

Typically the method further includes operating said computer system to maintain player profile data for each of said at least one players, said player profile data including data that is indicative of one or more sociological and/or one or more demographical characteristics of the respective player, and wherein said calculating said data is performed in respect of responses to the respective question made by a plurality of said at least one players whose respective player profile contains data indicating that said plurality of players share at least one common sociological and/or demographical characteristic, and preferably includes operating said computer system to calculate the respective target performance level from the respective player profile data that is indicative of the respective player's interaction with the computer system.

The respective target performance level may be calculated as a performance level that maximizes or optimizes the respective player's interaction with the computer system. The respective target performance level may be calculated as a performance level that maximizes or optimizes the respective player's interaction with the computer system with respect to the frequency with which the player uses the computer system, and/or the length of time the player engages with the system. Said target performance level is advantageously indicative of a target success rate for answering said questions correctly.

The preferred method further includes operating said computer system to calculate said current performance level as an indication of the respective player's actual success rate in answering said questions correctly during a current interaction with the system.

A second aspect of the invention provides a computer system for delivering a quiz comprising a plurality of questions to at least one player, the computer system comprising at least one server computing device in communication with at least one client computing device across a telecommunications network, the system including computer software configured to operate said computer system to:

store, in respect of each question, data representing a plurality of instances of said question in a computer usable format, each instance being associated with a different difficulty level;

maintain, in respect of each question, ranking data that enables the relative difficulty of the respective instances of each question to be determined;

determine a respective target performance level for a said at least one player;

present at said at least one client computing device a respective one of said instances of at least one question to said at least one player;

receive at said at least one client computing device a respective response to said at least one question from said at least one player;

calculate from said respective response a current performance level for said at least one player; compare said current performance level to said target performance level;

select one of said instances of a next question depending on said comparison; and

present said selected instance of said next question to said at least one player by said at least one computing client device,

wherein said selecting involves:
selecting one of said instances of said next question that is identified by said respective ranking data as being more difficult than the presented instance of a previously presented question if said comparing indicates that said current performance level exceeds said target performance level; and
selecting one of said instances of said next question that is identified by said respective ranking data as being less difficult than the presented instance of the previously presented question if said comparing indicates that said current performance level is lower than said target performance level.

Other preferred aspects of the invention will be apparent to those ordinarily skilled in the art upon review of the following description of a specific embodiment and with reference to the accompanying drawings.

### BRIEF DESCRIPTION OF THE DRAWINGS

An embodiment of the invention is now described by way of example and with reference to the accompanying drawings in which:

FIG. 1 is a block diagram of a computer-implemented system embodying one aspect of the present invention, the system being operable to provide an on-line quiz;

FIG. 2 is a flow chart illustrating the preferred operation of the system of FIG. 1; and

FIG. 3 is a table illustrating how socio-demographic factors can affect a player's ability to answer a question.

### DETAILED DESCRIPTION OF THE DRAWINGS

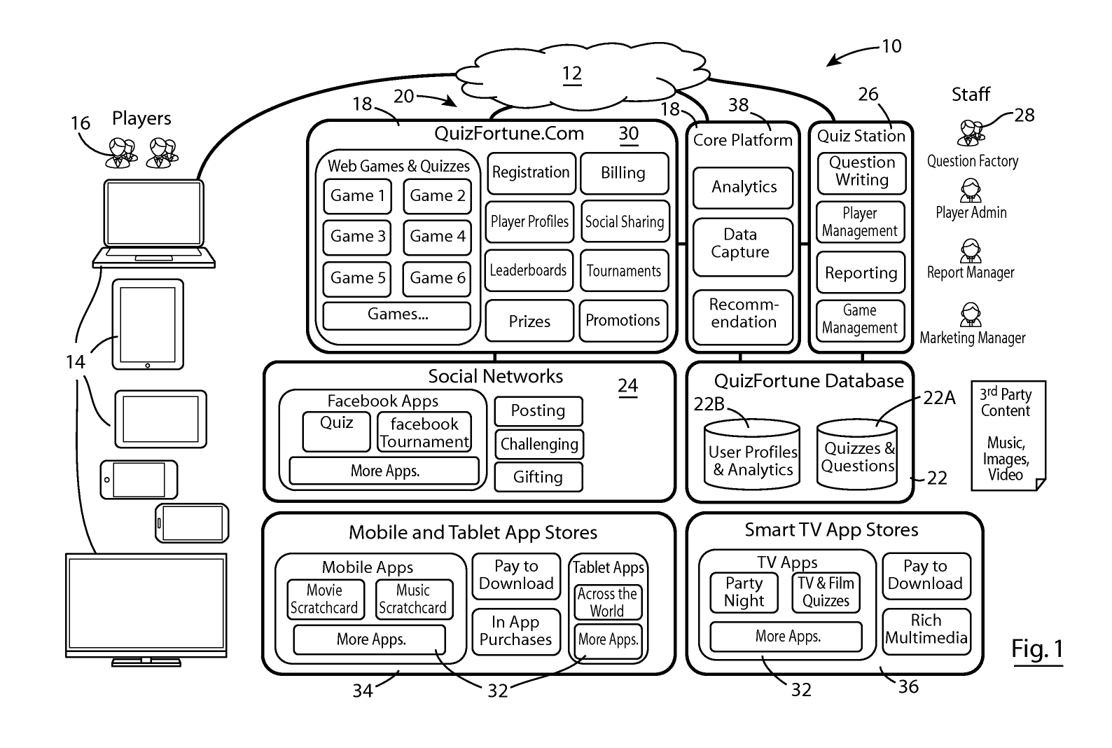

Referring now to FIG. 1 of the drawings there is shown, generally indicated as 10, an embodiment of a computer-implemented system that is operable to provide one or more quizzes, in particular an on-line quiz. The system 10 comprises a plurality of computing devices in communication with one another via a telecommunications network 12, typically comprising any one or more of the internet, a telephone network (e.g. public standard telephone network and/or cellular network) and/or one or more computer networks, any part of which may be wired or wireless as applicable. The computing devices comprise computer hardware supporting the operation of computer software to enable the system 10 to perform the operations described herein, or variations thereof. Other than as described herein, the computer hardware and software may be conventional.

The computing devices include at least one, but typically a plurality of, client computing devices 14, which may for example be a laptop computer, a personal computer, a smart television, or a mobile computing device such as a smart telephone, a tablet computer, a smart watch or a personal digital assistant. Each client computing device 14 is used by one or more player 16 to participate in one or more quizzes provided by the system 10. The client computing devices 14 include computer software to enable the client device 14 to operate and the player 16 to interact as described herein. The computer software may for example comprise a dedicated application (e.g. a mobile application or tablet application) or a web browser for running a web-based application.

The computing devices include at least one server computing device 18 which may comprise any suitable computer hardware supporting server software for providing services to the client devices 14 across the network 12. The server software may for example enable the server device(s) 18 to act as any one or more of a web server, database server, file server, gaming server or application server as applicable.

In the illustrated embodiment, the system 10 comprises a computing platform 20 for the delivery and management of quizzes, especially trivia-based quizzes, which is implemented by one or more server devices 18 as is convenient. The preferred computing platform supports computer software providing the following system components:
A database 22 (or other computer-implemented data storage facility)—the database stores all information generated by players 16 acting on the platform 20, including questions and quizzes, scores recorded by players 16, and analytics calculated by one or more components of the platform 20 based on recorded player behaviour. Typically, there are two logical databases (or other computer-implemented data storage facility):
   a database 22A for storing quizzes and questions—this is typically a read-mostly database that stores the questions and answers comprising the quiz, along with metadata that categorises and tags the questions and quizzes;
   a database 22B for storing player profiles and analytic data—this is typically a write-mostly database that records profile information entered by players during registration or collected from other sources, for example from a social networking computing platform 24, e.g. from Facebook (Trade Mark) during a sign in, along with all of the answers and timings recorded after a player has played a quiz;
a management component 26 (designated “QuizStation” in FIG. 1)—this is conveniently a web application (although it may implemented in any convenient manner) and comprises a content management software engine for the questions and quizzes. This component enables authorised user(s) 28, e.g. a question authoring team, to write questions, categorise and tag the questions and group the questions into quizzes. The questions and quizzes, together with any associated information (e.g. metadata), may then be stored in the database 22A. Quizzes can then be further categorised into quiz packs. The quizzes/quiz packs are made available to the players 16 in any convenient manner, e.g. published to the mobile or tablet applications or to a website 30. The management component 26 may also enable the authorised users 28 to perform other administrative, reporting or marketing tasks;
a website 30 (designated “QuizFortune.com” in FIG. 1)—the website 30 comprises one or more web applications for providing players 16 with the ability to play web-based quizzes, register, and sign in to view and manage their public user profile, using a web browser running on their client device 14;
one or more downloadable client applications 32 (shown in FIG. 1 as being available from a mobile and tablet “app store” 34 or a smart TV “app store” 36). These are typically dedicated mobile, table or smart TV applications that are downloadable by the client devices 14 to enable the players 16 to participate in the system 10.
A core platform component 38—this supports server software and may for example be implemented as a plurality of stateless HTTP REST web services. The various web applications of the website 30 and the management component 26, and the client applications 32 are configured to interface with the core platform 38, preferably to provide the following functionality:
   data capture: this involves the collection of statistics, in particular recording the scores submitted from the web and mobile applications 30, 32 after a quiz has been played.
   analytics: this involves analysing the recorded player statistics using one or more analytical computer-implemented services to, for example, identify patterns, generate leaderboards and rank the players according to their skill level on the quizzes they have played.
   recommendation: this involves providing various content recommendations. A particular example is a 2-player asynchronous mode ‘bot service’ which determines for a particular player and quiz whether a ‘bot’ (a simulated artificial intelligence player) or a ‘ghost’ (previously recorded answers and timings for a player playing the same quiz) is available, and deciding the skill of the bot or ghost for the real player to play against.

Operation of the preferred systems 10 is now described, particularly with regard to adjusting the difficulty of a quiz to a player profile to maximise player engagement. In this connection, the following definitions are adopted:
Player: a user 16 who selects a quiz and plays the quiz by answering questions one at a time
Player Profile: a user profile, provided to the system 10 by the user 16 and/or observed by the system 10, comprising computer usable data that identifies the player 16 as belonging to a particular player segment, which may be defined by one or more sociological and/or demographic factors (e.g. age, gender, nationality, place of residence) and/or other user-specific characteristics such as quiz-related data (e.g. data indicative of the number of quizzes in which the player has participated, the frequency with which the player participates in quizzes, and or the player's performance in the quizzes. For example, a player profile might contain data indicating that the player lives in the USA, is male, 24 years old, has played 200 quizzes, averaging 3 quizzes a day, and answering 60% of questions correctly.
Quiz: A named collection of questions, on a common topic, served one question at a time to a player 16.
Question: a question, preferably a multiple choice trivia question, comprising a Correct Answer and a plurality of Wrong Answers, and preferably a prompt, all being in computer usable form.
Correct Answer: the single correct answer to a question
Wrong Answers: multiple wrong answers presented alongside the correct answer as possible choices to the player 16.
Play: A particular instance of a play of a quiz by a player 16. A player can play the same quiz multiple times resulting in multiple plays.
Recorded Answer: the recorded choice of answer for a player 16 to a particular play of a particular quiz.

In preferred embodiments, operation of the system 10 is predicated around the following principles:

1. The same question can be repeatedly asked with different answer combinations (i.e. the correct answer together with a respective combination of wrong answers: for each question therefore, more wrong answers are written than are presented to a user as possible answers during a play. This enables the same question to be asked multiple times, with a different combination of answers each time. For example, for every multiple choice question having four possible answers, one of which is correct and three of which are wrong, an additional two wrong answers are written (e.g. by an authorised user 28 via the management component 26). By varying the combination of one correct answer and any 3 of 5 available wrong answers, the same question can be asked with a total of 10 different answer combinations (as maybe calculated by 5!/3!(5−3)!);

2. Wrong answers are ranked in order of likelihood that a player might believe them to be correct: When authoring answers the question author 28 assigns a respective difficulty level or rank to each of the possible wrong answers according to how obviously wrong they are. For example, each of the five wrong answers for a question are marked in decreasing order of likelihood of a player believing them to be correct. The rank data and the question can be stored in the database 22A as metadata for the respective question. In combination with the principle of varying the answer combinations, the rank data allows the same question can be asked with multiple (ten in the present example) differing degrees of difficulty, and that by varying the combination of wrong answers, the difficulty can be increased or increased according to the rank data. For example, if the five wrong answers are ranked from 1 to 5, where 1 indicates that a player is most likely to believe that the wrong answer is correct and 5 indicates that a player is least likely to believe that the answer is correct, then a combination of wrong answers ranked 3, 4 and 5 would be the easiest for the player to answer and the combination of wrong answers ranked 1, 2 and 3 would be the most difficult for the player to answer;

3. By asking enough players of a particular type of player profile (i.e. player profiles sharing one or more sociological or demographic characteristics) the same question, the system 10 can determine what is considered an easy or difficult question for players of that profile type: if the same question with the same combination of answers is asked repeatedly of different players sharing a common player profile type then the system 10 can determine an average probability of getting the answer correct, and therefore judge the relative difficulty of the respective question and answer combination for the respective player profile type. For example, the question ‘What is the capital of Estonia?’ with answers Talinn, Tbilisi, Ljubljana, Bratislava may be answered correctly by 100% of players from Estonia, 40% of players from UK, and 10% of players from USA. It can be seen for example that this question is more difficult for players having a player profile indicating that they are from the USA than those having a player profile indicating that they are from the UK. The question ‘What is the capital of Estonia?’ with answers Talinn, Los Angeles, Chicago, New York may be answered correctly by 100% of players from Estonia, 70% of players from UK and 90% of players from USA. It can be seen for example that this question is more difficult for players having a player profile indicating that they are from the UK than those having a player profile indicating that they are from the USA;

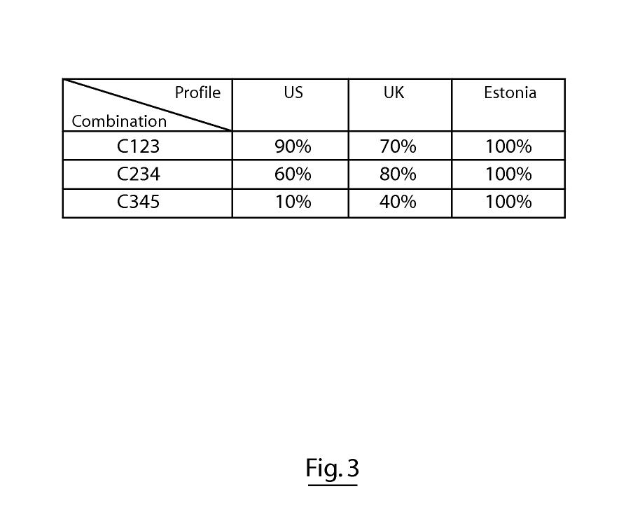

4. By comparing the difficulty of the same question with various different combinations of answers for the same player profile type (i.e. player profiles sharing one or more sociological or demographic characteristics), a question difficulty ranking can be determined for that player profile type: if the same question with the same combination of answers is asked repeatedly of different players of the same player profile type then the system can determine an average probability of getting the answer correct. For each player profile type this can be repeated for different combinations of answers, which allows the system 10 to determine the relative difficulty of the respective question and answer combination for the respective profile type. For example, with reference to FIG. 3, the probability of answering the same question with three different answer combinations correctly is shown, where C123 indicates the question presented with the correct answer C and with the three wrong answers ranked as 1, 2 and 3; C234 indicates the question presented with the correct answer C and with the three wrong answers ranked as 2, 3 and 4; and C345 indicates the question presented with the correct answer C and with the three 35 wrong answers ranked as 3, 4 and 5. It can be seen that relative difficulty of a question as indicated by the rank data assigned by the question's author 28 may be different than the relative difficulty of the question as indicated by the recorded players performance, and that this may vary depending on the player profile type. In the illustrated example of FIG. 3, the relative difficulty for players from the USA is the same as that indicated by the rank data, but for players from the UK and Estonia it is not. More generally it may be seen that the relative difficulty of the same question and answer combination can be different for different player profile types; and

5. The ideal, or optimal, difficulty of a quiz can be determined by measuring player engagement: by measuring the engagement across multiple, preferably all, players and comparing that engagement to the respective performance of the players, e.g. the number of questions they get right and wrong, the system 10 can correlate player performance with player engagement. This enables the system 10 to adjust the difficulty level of the questions being presented to a player 16 in order to maximise the player's 16 engagement. The system 10 may measure engagement by, for example, the number of plays (e.g. for a given player 16 and/or for a given player profile type and/or across all players (e.g. an average number of plays), and/or the frequency of play (e.g. for a given player 16 and/or given player profile type and/or across all players (e.g. an average frequency of play), and/or the length of play (e.g. for a given player 16 and/or given player profile type and/or across all players (e.g. an average length of play). Engagement may be measured in respect of any one or more quizzes and/or in respect of all quizzes, e.g. averaged across a plurality or all quizzes. For example, it may be determined that on average answering 65% of questions correctly makes players play more frequently while answering 70% of questions correctly makes players play for longer. If for example it is assumed that a single player wants to answer correctly 60% of the time, then if the player is getting more than 60% correct then the difficulty of the questions is increased.

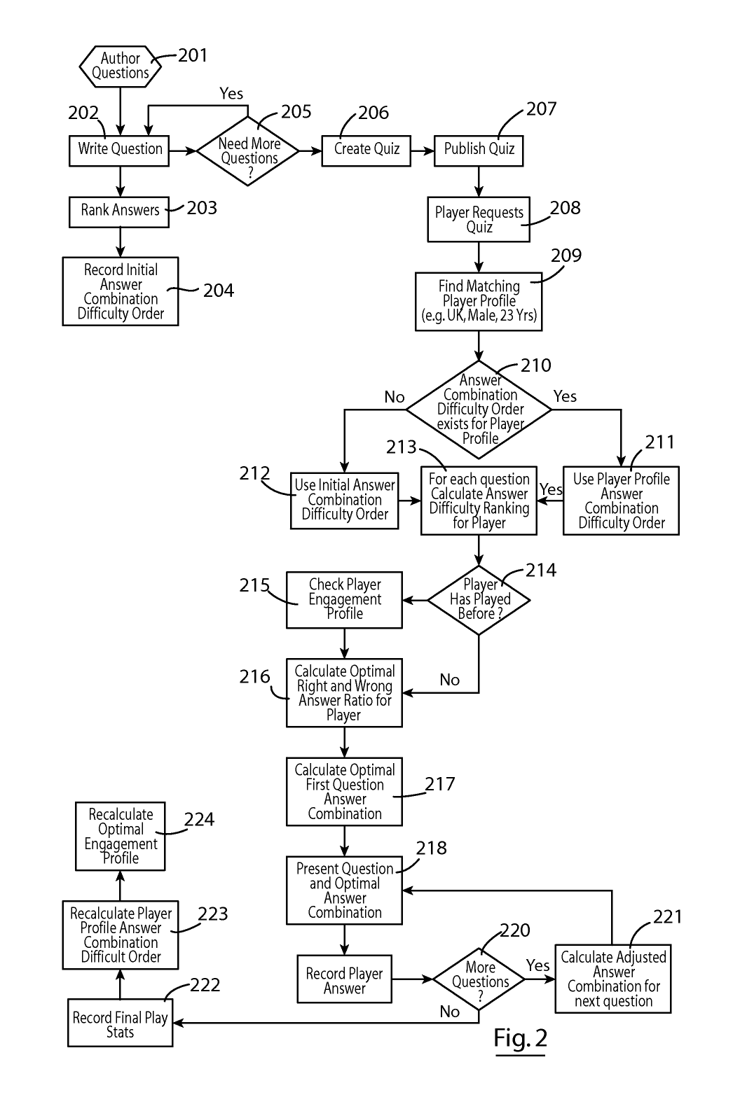

FIG. 2 illustrates an example of the operation of the preferred system 10, which involves adjusting the difficulty of a quiz to a player profile to maximise player engagement. The following description is made in the context of one player but it will be understood that multiple players may play simultaneously and be treated by the system in the same manner described herein for the single player.

In process steps 201 to 204 questions are created, where each question comprises the question itself, the correct answer and multiple wrong answers, preferably more wrong answers that are provided to a player 16 during play. This may be done by one or more users 28 via the management component 26, the questions and any associated metadata being stored in database 22A in computer usable form. For example, an authorised user 28 logs into the management component 26 to write questions (201). Using a question authoring function supported by the component 26, the user 28 creates a question by entering the question, the correct answer and multiple wrong answers, typically between 3 and 5 wrong answers (202). Advantageously more wrong answers are entered than are presented to a player when 35 the question is rendered during play to allow permutations of the question with varying degrees of difficulty to be presented as discussed above. The user 28 provides ranking data to the component 26 for association with the question (e.g. as metadata), the ranking data ranking the wrong answers in order of likelihood that a player might believe them to be correct (203). Using a save question function supported by the component 26, the question, correct answer and set of wrong answers are written to the database 22A with any associated metadata (204). Preferably, for each question, multiple instances of the question are stored in the database 22A, each instance having a respective different combination (or permutation) of wrong answers. The multiple instances are associated with respective ranking data or other metadata that is indicative of the relative difficulty of the respective instance compared to the other instances of the same question. Hence, the question is stored as a set of multiple variations of the question that are ranked in order of difficulty. This may be performed by the user 28 and/or by the component 26 as is convenient. When this is performed during question authoring (e.g. during step 204), the difficulty order may be determined using the ranking applied by the user 28, resulting in an initial answer combination difficulty order. The system 10 may associate one or more other answer combination difficulty orders with the set of questions, for example a respective difficulty order for multiple different player profile types, e.g. where the difficulty order is associated with one or more sociological and/or demographic characteristics that may be found in player profiles. This is typically performed by the system 10 using statistics gathered by the core platform component 38 from use of the system 10 by multiple players 16 with similar or different player profile types as applicable (see for example step 223 of FIG. 2), the difficulty orders being stored in the database 22.

The question authoring process may be repeated until a desired number of questions are created (205).

At step 206 one or more quizzes are created using the questions in the database 22A. This may be performed by a user 28 via the management component 26. Each quiz typically includes multiple questions, and creating a quiz involves grouping a plurality of the questions using the management component 26. The groupings may be recorded as metadata associated with the respective questions and may be stored in the database 22A. In cases where multiple instances of each question are stored, each instance is preferably included in the quiz group. In any event, all of the wrong answers are made available for each question so that the question may be presented with varying degrees of difficulty during the quiz.

At step 207, the, or each, quiz is published, i.e. made available to the players 16 by the system 10. This may be performed by the management component 26. Optionally, one or more quiz packs can be created and published, each quiz pack containing multiple quizzes. Quiz packs may for example be published under respective pack categories. Once published, the quizzes and quiz packs visible to and accessible by the players 16 via the website 30 or downloaded application 32 as applicable.

At step 208, a player 16 requests a quiz via the website 30 or downloaded application 32 using his client device 14. Each time the downloaded application 32 or web application is launched, it requests current quizzes from the quiz platform 20, displays them to the player 16 and makes them available for selection by the player 16. The player 16 chooses a quiz to play, for example by choosing a pack category, quiz pack, then a quiz from the pack, within the downloaded application or web application.

At step 209, the system 10 determines a player profile for the player 16 that has requested the quiz. To this end, each player 16 is preferably assigned a player identifier (ID), which is stored by the system 10, e.g. in the database 22B in the present example. The player ID may be created and stored by the system 10 during a player registration process (not illustrated) which may be performed by the player 16 using the downloaded application 32 or web application. The player ID is stored in association with a player profile for the player 16, the player profile comprising data that may be entered to the system 10 by the player 16 during registration, and/or obtained by the system 10 by any other appropriate means, e.g. from social networking sites or by recording statistics relating to the player's interaction with the system 10. Once registered, a player 16 is able to log in to the system 10 using a client device 14 and his player ID, the respective player profile being used and maintained by the system 10 in respect of the player's interaction with the system 10 while logged in. Alternatively, a player 16 may obtain a guest identifier (ID) for one-time plays. Such players 16 are preferably prompted by the system 10 to provide sociological and/or demographic information about themselves to allow the system 10 to create a player profile, otherwise a default player profile may be used. In any event, in step 209 the relevant player ID of the current player 16 is sent from the downloaded application 32 or web application to the platform 20 to enable the relevant player profile may be obtained by the system 10 for use during (and optionally after) play. This may involve retrieving and/or inspecting the player profile, which in this example is stored in database 22B.

At step 210, the system 10 determines if an answer combination difficulty order exists for the player profile of the current player 16. In the preferred embodiment, this is performed in respect of each question that is to be delivered to the current player 16. If an answer combination difficulty order exists for the player profile of the current player 16 then it is used (step 211) otherwise the initial answer combination difficulty order established during question authoring is used (step 212). This process is conveniently performed by the core platform component 38 using the database 22. Respective answer combination difficulty orders may be associated with a particular player profile type (e.g. defined by one or more sociological and/or demographic characteristics), and the player 16 may be associated with one or more player profile types. If more than one answer combination difficulty order exists for a given player, then one may be selected by the system 10 using any convenient criteria. It is more convenient however to associate each player 16 with only one player profile type, the type being determined by one or more of the parameters in his or her player profile (e.g. age, gender, nationality and/or place of residence).

At step 213, the relevant difficulty order (i.e. indicating the relative difficulty of the various permutations of the respective question) for each question to be delivered to the current player 16 is determined.

At step 214, the system 10 checks if the current player 16 has played previously. This may be performed by the core platform component 28 using the relevant player profile in database 22B. If the player 16 has played previously, then the system 10 inspects the relevant player profile to obtain player specific data that allows it to determine which instance of a question should be presented to the player 16 (step 215). In the preferred embodiment at step 215 this is performed in respect of the first question only, although in alternative embodiments it may be performed in respect of some or all of the questions to be delivered to the player 16. The player specific data obtained from the player profile to allow this determination to be made may comprise information that is indicative of the skill of the player 16. To this end, the system may maintain a skill level parameter in each player profile, or the skill level may be deduced from one or more other parameters included in the player profile. Alternatively or in addition, the obtained user specific data may comprise information relating to the user's previous engagements with the system 10 that help to determine which instance of a question should be presented to the player 16, for example the difficulty level of questions that tend to maximize the length, number and/or frequency of the user's engagements with the system 10.

At step 216, the system 10 determines a target performance level (e.g. ratio of correct answers to wrong answers) for the current player 16, preferably a target performance level that will maximize the player's engagement with the system 10. This may be calculated using the player specific data obtained in step 215 for players that have played before and/or any other relevant data contained in the player profile. Alternatively, the target performance level may be stored as a parameter in the relevant player profile. In any case, the target performance level may be calculated by the system 10, in particular by the core platform component 38, based on information provided by the player and/or collected by the system 10 in relation to the player 16 during use. At step 214 if it is determined that the player 16 has no previous engagement, control may pass directly to step 216. In this case, the target performance level may be calculated from profile data provided by the player 16 during registration or guest log in, and/or using statistics gathered by the system 10 from other players. Alternatively a default target performance level may be used.

At step 217, the system 10 calculates which instance of a question should be presented to the player 16. In the preferred embodiment at step 215 this is performed in respect of the first question only, although in alternative embodiments it may be performed in respect of some or all of the questions to be delivered to the player 16. In preferred embodiments, this calculation is performed using the target performance level determined at step 216 and/or the skill level determined at step 215 in conjunction with the relevant answer combination difficulty order for the question. For example, if the target performance level is 90% correct answers, and the player's skill is relatively low, then the system 10 may select the instance of the question that is deemed to be easiest according to the relevant difficulty order for the question. This calculation is conveniently performed by the core platform component 38.

At step 218, the selected instance of the question is presented to the player 16 via the downloaded application 32 or web application as applicable. The downloaded application 32 or web application allows the player 16 to respond to the question by selecting one of the presented answers, and the player's response is recorded by the system 10 (step 219). The user's responses and/or statistics generated therefrom may be recorded initially by the downloaded application 32 or web application and may be communicated to the core platform component 38 during or after play.

At step 220, the system 10 determines if any further questions are to be presented to the player 16. If so, then at step 221 the system 10 determines if an adjustment of the level of difficulty of the questions being delivered to the player 16 is required and, if so, makes an appropriate adjustment. In preferred embodiments this involves calculating the player's current performance (e.g. the ratio of correct answers to wrong answers or percentage of correct answers) and comparing the current performance with the target performance. If the current performance exceeds the target performance, then the system 10 may decide to increase the difficulty of the next question to be asked compared to the previous question. If the current performance is lower than the target performance, then the system 10 may decide to decrease the difficulty of the next question to be asked compared to the previous question. Increasing or decreasing the difficulty of the next question may be achieved by selecting an instance of the next question that is ranked by the relevant answer combination difficulty order as being more difficult or less difficult, respectively, than indicated by the rank of the previous presented question. This calculation and adjustment may be made by the core platform component 38 in conjunction with the data held in the database 22. Once the instance of the next question has been selected, steps 218 to 220 are repeated until no further questions are required.

When there are no more questions to present, data relating to the play (e.g. the responses, the performance level, scores and timings) is recorded in the database 22 by the core platform component 38 (step 222).

At steps 223 and 224, the recorded data is used by the system, and in particular by the core platform component 38, to create and/or modify data held by the system in database 22, including one or more parameters (e.g. skill level and/or target performance level or other engagement related statistics) of the player profile for the current player 16 and/or one or more answer combination difficulty orders held for one or more of the questions that has just been asked. For example, the player profile of the current player 16 may include one or more parameters indicating one or more sociological or demographic characteristics (e.g. age, gender, nationality, place of residence) that are shared by other player profiles and which can therefore be associated with one or more player profile types. As described above the system advantageously holds data that can be associated with player profile types, for example relating to the engagement characteristics of players of a profile type, and/or relating to the relative difficulty of the various instances of questions to players of a profile type (see for example FIG. 3 and the accompanying description). The data recorded at step 222, and data calculated therefrom, can be used to update the data held in respect of player profile types. Conveniently this is performed by the core platform component 38 and the results are stored in the database 22. The answer combination difficulty order used in step 211 is an example of data that may be held by the system 10 (typically in database 22A) in respect of a player profile type and updated in the manner described above.

It will be apparent from the foregoing that the preferred system 10 is capable of adjusting the level of difficulty of questions presented to a player during play in order to optimise or maximise the player's engagement with the system 10, the adjustment advantageously taking into account one or more sociological and/or demographic characteristics of the player.

It will be understood that what has been described herein is an exemplary computer system for implementing a quiz. While the present teaching has been described with reference to exemplary arrangements it will be understood that it is not intended to limit the teaching to such arrangements as modifications can be made without departing from the spirit and scope of the present teaching.

It will be understood that while exemplary features of a computer-implemented quiz system in accordance with the present teaching have been described that such an arrangement is not to be construed as limiting the invention to such features. The method of the present teaching may be implemented in software, firmware, hardware, or a combination thereof. In one mode, the method is implemented in software, as one or more executable program, and is executed by one or more special or general purpose digital computer(s), such as a personal computer (PC; IBM-compatible, Apple-compatible, or otherwise), personal digital assistant, workstation, minicomputer, or mainframe computer. The steps of the method may be implemented by a server or computer in which the software modules reside or partially reside.

All of the data used by the system 10, including the questions, answers and player profiles, is provided in any conventional electronic or otherwise computer usable form.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functions of the method as described above. The processor(s) is a hardware device for executing software, particularly software stored in memory. Processor(s) can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions.

Memory is associated with processor(s) and can include any one or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s). The software in memory may include one or more separate programs. The separate programs comprise ordered listings of executable instructions for implementing logical functions in order to implement the functions of the modules. In the example of heretofore described, the software in memory includes the one or more components of the method and is executable on a suitable operating system (O/S).

The present teaching may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

When the method is implemented in software, it should be noted that such software can be stored on any computer readable medium for use by or in connection with any computer related system or method. In the context of this teaching, a computer readable medium is an electronic, magnetic, optical, or other physical device or means that can contain or store a computer program for use by or in connection with a computer related system or method. Such an arrangement can be embodied in any computer readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. Any process descriptions or blocks in the Figures, should be understood as representing modules, segments, or portions of code which include one or more executable instructions for implementing specific logical functions or steps in the process, as would be understood by those having ordinary skill in the art.

It should be emphasized that the above-described embodiments of the present teaching, particularly, any “preferred” embodiments, are possible examples of implementations, merely set forth for a clear understanding of the principles. Many variations and modifications may be made to the above-described embodiments.

The invention is not limited to the embodiment(s) described herein but can be amended or modified without departing from the scope of the present invention.

1. A computer-implemented method of delivering a quiz comprising a plurality of questions to at least one player using a computer system, the computer system comprising at least one server computing device in communication with at least one client computing device across a telecommunications network, the method comprising operating said computer system to:
store, in respect of each question, data representing a plurality of instances of said question in a computer usable format, each instance being associated with a different difficulty level;
maintain, in respect of each question, ranking data that enables the relative difficulty of the respective instances of each question to be determined;
determine a respective target performance level for a said at least one player;
present at said at least one client computing device a respective one of said instances of at least one question to said at least one player;
receive at said at least one client computing device a respective response to said at least one question from said at least one player;
calculate from said respective response a current performance level for said at least one player;
compare said current performance level to said target performance level;
select one of said instances of a next question depending on said comparison; and
present said selected instance of said next question to said at least one player by said at least one computing client device,
wherein said selecting involves:
selecting one of said instances of said next question that is identified by said respective ranking data as being more difficult than the presented instance of a previously presented question if said comparing indicates that said current performance level exceeds said target performance level; and
selecting one of said instances of said next question that is identified by said respective ranking data as being less difficult than the presented instance of the previously presented question if said comparing indicates that said current performance level is lower than said target performance level.

2. The method of claim 1, wherein said data representing a plurality of instances of said question comprises data representing the respective question, a correct answer to the question and a respective different combination of wrong answers.

3. The method of claim 2, wherein said ranking data comprises, in respect of each wrong answer, data that is indicative of the respective probability that said at least one player would select the respective wrong answer as the correct answer.

4. The method of claim 3, further including operating said computer system to receive said data that is indicative of the respective probability that said at least one player would select the respective wrong answer as the correct answer as an input at a respective one of said at least one client devices.

5. The method of claim 3, further including calculating said data that is indicative of the respective probability that said at least one player would select the respective wrong answer as the correct answer from responses to the respective question made by said at least one player using said at least one client computing device.

6. The method as claimed in claim 5, wherein said calculating said data is performed in respect of responses to the respective question made by a plurality of said at least one players.

7. The method of claim 1, further including operating said computer system to maintain player profile data for each of said at least one players, said player profile data including data that is indicative of one or more sociological and/or one or more demographical characteristics of the respective player.

8. The method of claim 7, wherein said data that is indicative of one or more sociological and/or one or more demographical characteristics of the respective player comprises data indicative of any one or more of the respective player's age, gender, nationality or place of residence.

9. The method of claim 1, further including operating said computer system to maintain player profile data for each of said at least one players, said player profile data including data that is indicative of the respective player's interaction with the computer system.

10. The method of claim 9, wherein said data that is indicative of the respective player's interaction with the system comprises data indicative of any one or more of a number of times the player has played the quiz, the frequency with which the player uses the computer system, the length of time the player engages with the system (on average and/or for each engagement), the player's performance in answering said questions (on average and/or for each engagement), said target performance for said player, a skill level for said player.

11. The method of claim 6, further including operating said computer system to maintain player profile data for each of said at least one players, said player profile data including data that is indicative of one or more sociological and/or one or more demographical characteristics of the respective player, and wherein said calculating said data is performed in respect of responses to the respective question made by a plurality of said at least one players whose respective player profile contains data indicating that said plurality of players share at least one common sociological and/or demographical characteristic.

12. The method of claim 9, further including operating said computer system to calculate the respective target performance level from the respective player profile data that is indicative of the respective player's interaction with the computer system.

13. The method of claim 12, wherein the respective target performance level is calculated as a performance level that maximizes or optimizes the respective player's interaction with the computer system.

14. The method of claim 13, wherein the respective target performance level is calculated as a performance level that maximizes or optimizes the respective player's interaction with the computer system with respect to the frequency with which the player uses the computer system, and/or the length of time the player engages with the system.

15. The method of claim 1, wherein said target performance level is indicative of a target success rate for answering said questions correctly.

16. The method of claim 1, further including operating said computer system to calculate said current performance level as an indication of the respective player's actual success rate in answering said questions correctly during a current interaction with the system.

17. A computer system for delivering a quiz comprising a plurality of questions to at least one player, the computer system comprising at least one server computing device in communication with at least one client computing device across a telecommunications network, the system including computer software configured to operate said computer system to:
store, in respect of each question, data representing a plurality of instances of said question in a computer usable format, each instance being associated with a different difficulty level;
maintain, in respect of each question, ranking data that enables the relative difficulty of the respective instances of each question to be determined;
determine a respective target performance level for a said at least one player;
present at said at least one client computing device a respective one of said instances of at least one question to said at least one player;
receive at said at least one client computing device a respective response to said at least one question from said at least one player;
calculate from said respective response a current performance level for said at least one player;
compare said current performance level to said target performance level;
select one of said instances of a next question depending on said comparison; and
present said selected instance of said next question to said at least one player by said at least one computing client device,
wherein said selecting involves:
selecting one of said instances of said next question that is identified by said respective ranking data as being more difficult than the presented instance of a previously presented question if said comparing indicates that said current performance level exceeds said target performance level; and
selecting one of said instances of said next question that is identified by said respective ranking data as being less difficult than the presented instance of the previously presented question if said comparing indicates that said current performance level is lower than said target performance level.
